(19) United States
(12) Patent Application Publication
(10) Pub. No.: US 2011/0191386 A1
(43) Pub. Date: Aug. 4, 2011

(54) Method and Apparatus for Data Extraction from Extensible Markup Language File

(76) Inventor: Wei-Lun Huang, Taipei Hsien (TW)

(21) Appl. No.: 12/984,616

(22) Filed: Jan. 5, 2011

(30) Foreign Application Priority Data
Feb. 1, 2010 (TW) 099102788

(51) Int. Cl. G06F 17/30

(52) U.S. Cl. 707/802; 707/E17.005

(57) ABSTRACT

A data extraction method, for obtaining data via the Internet, includes obtaining an extensible markup language file, comprising a plurality of elements corresponding to a plurality of tags, from a server terminal according to a user command, for obtaining the specific element in the extensible markup language file, performing a format analysis to obtain a format analysis result, choosing a template from a plurality of templates, for indicating contents of the plurality of tags, and obtaining the specific element in the extensible markup language file via the template.

### BACKGROUND OF THE INVENTION

1. Field of the Invention

The present invention relates to a data extraction method and an apparatus for extracting data from extensible markup language files, and more particularly, to a data extraction method and apparatus which are reusable and greatly enhance utilization efficiency.

2. Description of the Prior Art

In recent years, due to prosperity of the Internet, almost all data have to be transmitted via the Internet. Among them, since an extensible markup language (XML) file has an excellent feature of cross-platform and a superior ability to express data information, most Internet transmissions are performed with XML. However, even if each website uses XML files to store data, different websites use different tags to mark identical elements. For example, please refer to FIG. 1 and FIG. 2. FIG. 1 and FIG. 2 are respectively schematic diagrams of contents of an XML file 10 and an XML file 20. The XML file 10 and the XML file 20 have identical elements and structures, but the tags marking book lists are respectively named <Books> in the XML file 10 and named <Booklist> in the XML file 20. When an user tries to extract the two elements “XML guidelines” and “HTML guidelines” from the XML file 10, the user must extract the two elements along a route of <Books>\<Book>\<Name>. On the contrary, when the user tries to extract the two elements “XML guidelines” and “HTML guidelines” from the XML file 20, the user must extract the elements along a route of <Booklist>\<Book>\<Name>. That is to say, to accurately extract contents of XML files, a programmer has to adopt two different ways for the XML file 10 and the XML file 20.

In addition to different denominations of tags, structures of XML files provided by different websites are different as well. For example, please refer to FIG. 1 and FIG. 3 simultaneously. FIG. 3 is a schematic diagram of an XML file 30. The tags marking book lists in the XML file 10 and in the XML file 30 are both <Books>, and the elements in books portion in the XML file 10 and the XML file 30 are also identical. However, structures of the two files are different. When the user tries to extract elements “XML guidelines” and “HTML guidelines” from the XML file 10, the user has to extract them along route <Books>\<Book>\<Name>. On the contrary, when the user tries to extract the two elements “XML guidelines” and “HTML guidelines” from the XML file 30, the user must extract them along route <2009>\<Books>\<Book>\<Name>. That is to say, to accurately extract contents of XML files, the user has to adopt two different methods for the XML file 10 and the XML file 30. In other words, the user has to adopt different methods for the websites with different tags, hence resulting in waste of resources and inefficiency, which is necessary to be improved.

### SUMMARY OF THE INVENTION

It is therefore a primary objective of the claimed invention to provide a data extraction method and apparatus for extensible markup language files capable of reuse.

An embodiment of the invention discloses a data extraction method, for obtaining data via the Internet. The data extraction method includes obtaining an extensible markup language file, including a plurality of elements corresponding to a plurality of tags, from a server terminal according to a user command, for obtaining a specific element in the extensible markup language file, performing a format analysis to obtain a format analysis result, choosing a template from a plurality of templates, for indicating contents of the plurality of tags, and obtaining the specific element in the extensible markup language file via the template.

An embodiment of the invention further discloses a data extraction apparatus, for obtaining data via the Internet. The data extraction device includes a micro processor and a memory. The memory is utilized for storing a program, and the program is utilized for indicating the micro processor to execute the following steps: obtaining an extensible markup language file, comprising a plurality of elements corresponding to a plurality of tags, from a server terminal according to a user command, for obtaining the specific element in the extensible markup language file, performing a format analysis to obtain a format analysis result, choosing a template from a plurality of templates, for indicating contents of the plurality of tags, and obtaining a specific element in the extensible markup language file via the template.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of a conventional XML file.

FIG. 2 is a schematic diagram of a conventional XML file.

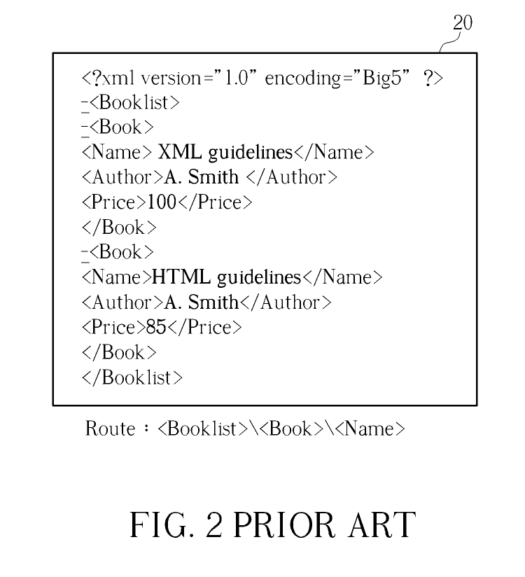

FIG. 3 is a schematic diagram of a conventional XML file.

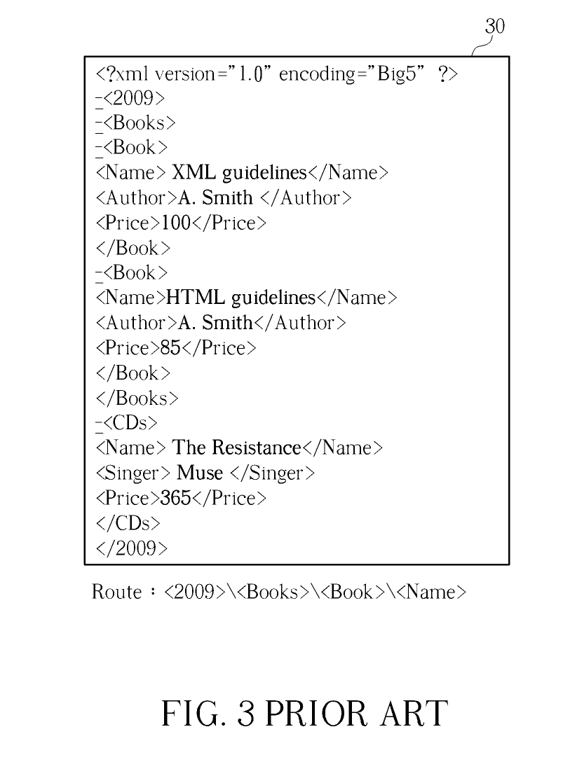

FIG. 4 is a schematic diagram of a data extraction process according to an embodiment of the invention.

FIG. 5 is a schematic diagram of a format analysis result according to an embodiment of the invention.

FIG. 6 is a schematic diagram of a template according to an embodiment of the invention.

### DETAILED DESCRIPTION

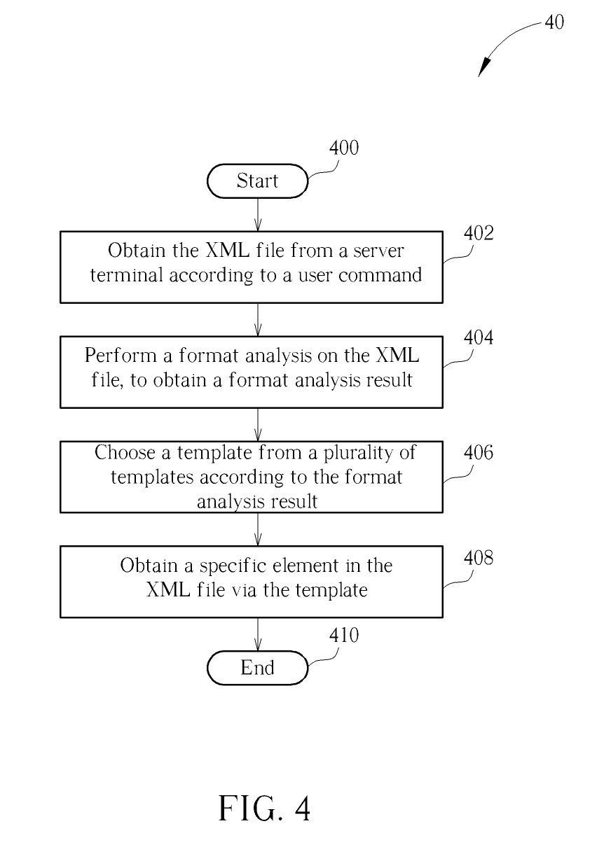

To improve data extraction process of XML files in the prior art, the invention applies a specific template to indicate contents of tags, so as to connect a user command for obtaining a specific element in the XML file with a tag, and to obtain the specific element corresponding to the tag in the XML file. First, please refer to FIG. 4. FIG. 4 is a schematic diagram of a data extraction process 40 according to an embodiment of the invention. The data extraction process 40 is utilized for extracting a specific element in an XML file, and includes the following steps:

Step 400: Start.

Step 402: Obtain the XML file from a server terminal according to a user command.

Step 404: Perform a format analysis on the XML file, to obtain a format analysis result.

Step 406: Choose a template from a plurality of templates according to the format analysis result.

Step 408: Obtain a specific element in the XML file via the template.

Step 410: End.

According to the data extraction process 40, the invention obtains the XML file from a server terminal according to the user command, chooses the corresponding template via the format analysis, and obtains a specific element in the XML file.

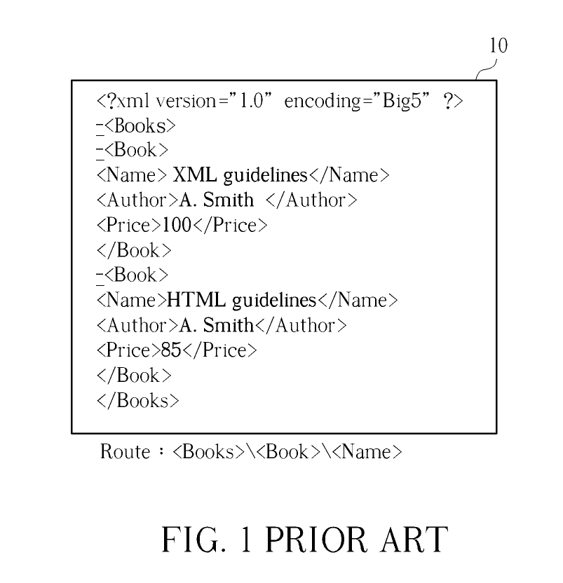

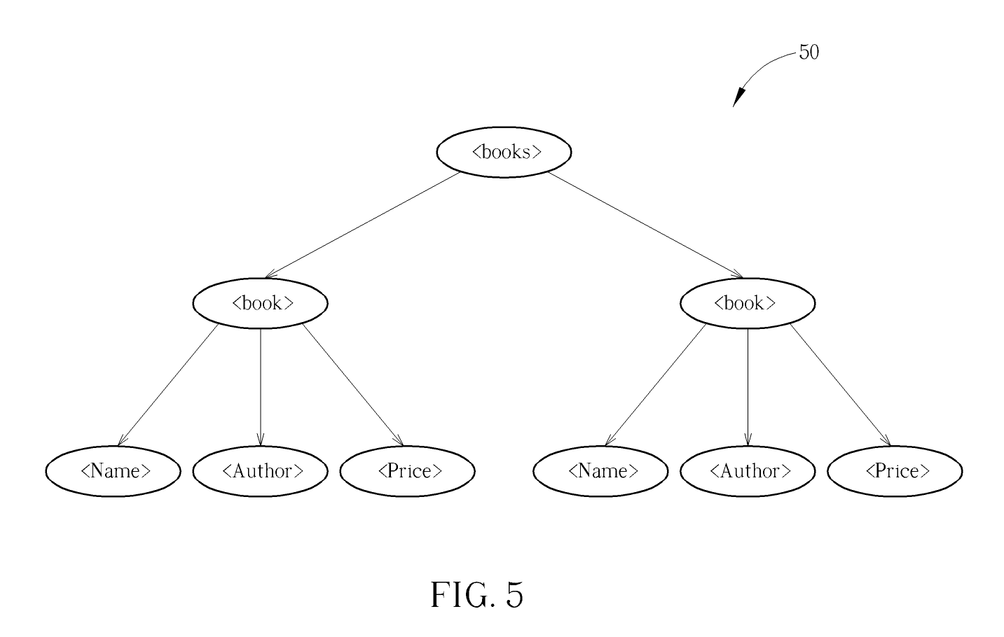

In the data extraction process 40, the user command includes two parts. One is a denomination of the XML file, and the other is a denomination of the element to be obtained. After obtaining the XML file according to the user command, the invention (Step 404) further performs the format analysis on the XML file, and obtains the format analysis result. The format analysis step transforms all tags in the XML file into a tree structure, which is well-known for those skilled in the art and is abridged as follows. First, every tag in the XML file is taken as a node, and the initial tag is taken as a root (Root). Then, take tags folded in a tag as located in a layer and transform the tags in the XML file into the tree structure with hierarchical nodes according to the rule that the latter is in the next layer of the former. In other words, the tree structure includes a plurality of nodes, and each node is corresponding to a tag. For example, please refer to FIG. 5. FIG. 5 is a schematic diagram of a format analysis result 50 according to an embodiment of the invention. The format analysis result 50 is transformed from the XML file 10 in FIG. 1. The root of the format analysis result 50 is the tag <Books>, the next layer comprises two nodes with the same tag <Book>, and the further next layer comprises six nodes with tags <Name>, <Author>, and <Price>, respectively. That is, the format analysis result 50 is a three-layer tree structure, i.e. the XML file 10 has a three-layer structure.

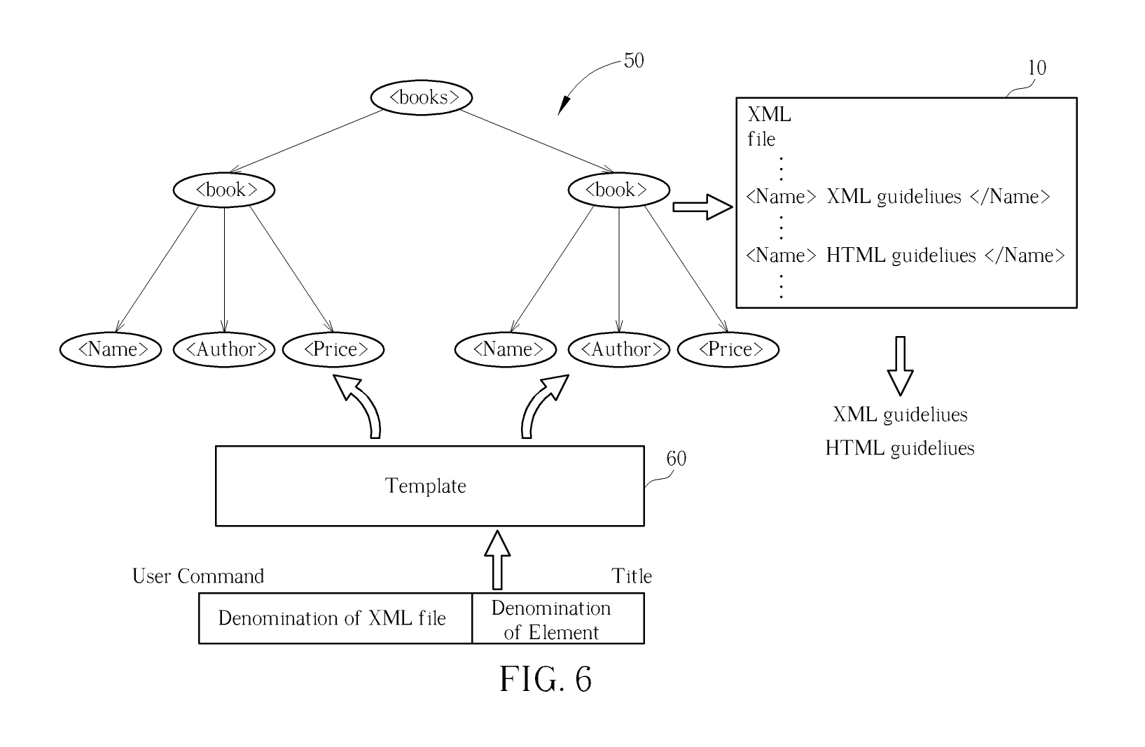

Next, according to the format analysis result, the structure of the XML file can be obtained. Accordingly, the invention (Step 406) chooses an appropriate template from the plurality of predetermined templates, to indicate contents of the tags in the XML file. For example, the format analysis result 50 described above is a three-layer tree structure, and the XML file 10 has a three-layer structure; therefore, a three-layer template should be selected from the templates. Meanwhile, as to the XML file 10, a template, utilized for extracting data of books and capable of recognizing tags like <Book>, <Name>, <Author>, and <Price>, should be selected, such as a three-layer template 60 shown in FIG. 6, in order to properly define each tag and the corresponding node in the XML file 10. In detail, as to the tag <Book> in the XML file 10, the template 60 confirms that the tag <Book> in the XML 10 is utilized for marking individual books according to the corresponding node located in the second layer of the tree structure and the denomination of the tag <Book>, and the tags like <Name>, <Author>, and <Price> or <Title>, <Writer>, and <Price> should be in the next layer. Similarly, as to the tag <Name> in the XML file 10, the template 60 confirms that the tag <Name> in the XML 10 is utilized for marking individual names according to the corresponding node located in the third layer of the tree structure and denomination of the tag <Name>, and tags like <Author>, <Price> or <Writer>, <Price> should be in the same layer. In other words, the invention chooses the template 60 according to the structure and classification of contents of the XML file, and the template 60 determines comprehensively meanings of the tags and the corresponding elements in the XML file.

Furthermore, via the template 60, the invention can obtain a specific element indicated by the user command from XML files, and the steps include determining the denomination of the element first and then obtaining the corresponding node from all nodes via the template 60. Accordingly, the tag corresponding to the node can be determined, so as to obtain the corresponding element from the XML file, i.e. the specific element indicated by the user command.

As can be seen from the above, in the invention, the template defines the denomination of the specific element indicated by the user command, as well as the tags and the corresponding nodes in the XML file, and make the denomination of the specific element corresponding to a specific node of the format analysis result. For example, via the template 60, the denomination of the specific element like <Title> is corresponding to the specific node including the tag <Name> in the format analysis result 50 and the tag <Name> in the XML file 10. Thus, the template 60 can point the corresponding node defined in the format analysis result 50 according to denomination of the specific element. The purpose can be achieved by other ways such as an additional denomination table of the specific elements, which are well known by those skilled in the art.

Moreover, the invention determines a tag corresponding to the node, to obtain the element corresponding to the tag from the XML file. In other words, when the specific node is corresponding to the tag <Name> in the format analysis result 50, the element with the tag <Name> can be obtained from the XML file 10.

Please note that, the template 60 and the method of determining each tag and the corresponding element are only embodiments of the invention. Meanwhile, the spirit of the invention is to define tags in the XML file and the corresponding elements according to the templates. Therefore, choosing different templates, the invention can perform data extraction for different XML files. That is, the invention can extract specific data from the XML file 20 and XML file 30. For example, if the user intends to obtain information of authors in the XML file 20 and enters a user command including a filename of the XML file 20 and a denomination of the element <Writer>, the invention identifies that the XML file 20 is corresponding to a three-layer structure via the format analysis, and chooses a three-layer template from the predetermined templates. Meanwhile, to meet the contents of the XML file 20, a template, utilized for extracting data of books and capable of determining the tags like <Book>, <Name>, <Author>, and <Price>, should be selected, such as a three-layer template capable of determining the tags like <Book>, <Name>, <Author>, and <Price> or <Booklist>, <Title>, <Writer>, and <Price>, i.e. the template 60. Then, a format analysis result is generated. Via the template 60, <Writer> in the user commands is corresponding to a specific node having the tag <Author> in the format analysis result and the tag <Author> in the XML file 20. In other words, in addition to the above examples, the template 60 can be further utilized for extracting data from different XML files, thus enhancing the utilization efficiency. As to the XML file 30, a four-layer template, utilized for extracting data of books and capable of determining the relative tags, should be selected. The rest part can be derived as mentioned above, and such derivatives can be easily achieved by those skilled in the art. Also, various templates can further be obtained according to different demands.

Regarding hardware implement, the data extraction process 40 can be converted into a program stored in a memory for indicating a micro processor to execute the steps thereof. Converting the data extraction process 40 into an appropriate program to implement the corresponding data extraction apparatus should be well known for those skilled in the art.

As mentioned above, in the prior art, for coping with different denominations and structures of tags in XML files, the user has to adopt different measures for websites using different tags, to accurately extract contents of the XML files. In contrast, the invention chooses appropriate templates via the format analysis, and establishes the connection between the tags and the denomination of the specific element to be extracted by the user, such that the present invention can perform data extraction for different XML files and is free from the restriction of different browsers or development environments.

To sum up, the present invention defines tags of XML files and the corresponding elements and establishes the connection between the tags and the denomination of the specific element to be extracted by the user via the appropriate template, such that the user can extract the specific element from the XML file without recognizing the tags. Hence, the present invention can repeatedly perform data extraction for different XML files, and is free from restrictions of different browsers and development environments, to enhance utilization efficiency significantly.

Those skilled in the art will readily observe that numerous modifications and alterations of the device and method may be made while retaining the teachings of the invention.

What is claimed is:

1. A data extraction method, for obtaining data via the Internet, the data extraction method comprising:
obtaining an extensible markup language file, comprising a plurality of elements corresponding to a plurality of tags, from a server terminal according to a user command, for obtaining a specific element in the extensible markup language file;
performing a format analysis on the extensible markup language file, to obtain a format analysis result;
choosing a template from a plurality of templates, for indicating contents of the plurality of tags; and
obtaining the specific element in the extensible markup language file via the template.

2. The data extraction method of claim 1, wherein the step of performing the format analysis to obtain the format analysis result comprises:
transforming the plurality of tags of the extensible markup language file to a tree structure as the format analysis result, the tree structure comprising a plurality of nodes, each node corresponding to a tag of the plurality of tags.

3. The data extraction method of claim 2, wherein the step of obtaining the specific element in the extensible markup language file via the template comprises:
determining denomination of the specific element according to the user command;
obtaining a node corresponding to the specific element via the template, according to the denomination of the specific element; and
determining a tag corresponding to the node, so as to obtain the specific element corresponding to the tag from the extensible markup language file.

4. The data extraction method of claim 2, further comprising storing the tree structure.

5. A data extraction device, for obtaining data via the Internet, the data extraction device comprising:
a micro processor; and
a memory, for storing a program, the program for indicating the micro processor to execute the following steps:
obtaining an extensible markup language file, comprising a plurality of elements corresponding to a plurality of tags, from a server terminal according to a user command, for obtaining the specific element in the extensible markup language file;
performing a format analysis on the extensible markup language file, to obtain a format analysis result;
choosing a template from a plurality of templates, for indicating contents of the plurality of tags; and
obtaining a specific element in the extensible markup language file via the template.

6. The data extraction device of claim 5, wherein the step of performing the format analysis to obtain the format analysis result comprises:
transforming the plurality of tags of the extensible markup language file to a tree structure as the format analysis result, the tree structure comprising a plurality of nodes, each node corresponding to a tag of the plurality of tags.

7. The data extraction device of claim 6, wherein the step of obtaining the specific element in the extensible markup language file via the template comprises:
determining denomination of the specific element according to the user command;
obtaining a node corresponding to the specific element via the template, according to the denomination of the specific element; and
determining a tag corresponding to the node, so as to obtain the specific element corresponding to the tag from the extensible markup language file.

8. The data extraction device of claim 6, further comprising storing the tree structure.
